(19) United States
(12) Patent Application Publication
(10) Pub. No.: US 2010/0288893 A1
(43) Pub. Date: Nov. 18, 2010

(54) SUCTION CUP FOR HOLDING POLES

(76) Inventor: Greg Tan, Harahan, LA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/464,683

(22) Filed: May 12, 2009

(51) Int. Cl. F16B 47/00

(52) U.S. Cl. 248/205.5

(57) ABSTRACT

A suction cup for holding includes a suction cup portion formed of resilient material that has a concave surface and an opposite convex surface. A pole holding assembly is formed of resilient material, has at least one planar surface and is attached to the convex surface such that the planar surface is perpendicular to a plane formed by a perimeter of the concave surface. The assembly has at least one through hole. The through hole is at right angles to the planar surface and is sized and shaped to grip a pole. When the suction cup portion is pressed onto a smooth surface and a pole is positioned within a through hole, the pole is maintained in a position parallel to the smooth surface. The through holes include interior ridges for improved grip. A release arm is attached adjacent an outer edge of the convex surface for suction cup removal.

### FIELD OF INVENTION

This invention relates to the field of packaging facilities, and more specifically to a mounting device for poles to which plastic bag dispensers are attached.

### BACKGROUND OF THE INVENTION

In modern grocery stores and supermarkets space is often at a premium. This is particularly so in produce departments where all available space is used to display fruits and vegetables to best advantage. Customers shopping in these produce departments need to have rapid access to produce bags into which to place their purchases. Plastic produce bags are typically packaged in rolls and the rolls are stored in bag dispensers. Produce bags may also be designed with tear-off headers and the headers affixed to suitable bag dispensers. Typically these various types of bag dispensers are affixed to produce racks where space is available. As some customers are taller than others, it is advantageous to position bag dispensers at different heights in the produce area. The present invention is designed to make use of smooth wall or counter surfaces to provide a secure mounting for up to three poles. Different designs of bag dispensers can then be affixed to these poles at different heights or in different horizontal positions. Thus the present invention will allow the produce department to make more efficient use of the available space and provide bag dispensers to customers that are conveniently located.

Various suction cup based mounting systems have been developed addressing similar problems. U.S. Pat. No. 1,743,694, issued to Tierney, is directed to an article support in which a suction cup is attached to a vertical surface with provision for holding a flag staff within an aperture. The resulting configuration is that the flag or staff is held in a plane that is parallel to the plane of the surface to which the suction cup is attached. U.S. Pat. No. 1,743,442, directed to a flag holder, shows a similar structure. U.S. Pat. No. 1,267,270, directed to a vacuum cup shows a structure with a ring attached to a cup-shaped member supported on a glass plane. Here, a pole which is placed within the ring would lie in a plane parallel to the plane of the glass panel.

U.S. Pat. No. 4,846,429, issued to Scheurer et al. is directed to a releasable suction cup assembly having a vacuum release strap which is attached to the suction cup for dislodging the suction cup from a smooth surface.

U.S. Pat. No. 6,402,104, issued to Smith is directed to a suction cup-supported bathroom accessory in which the holder has a plurality of notches so that more than one article may be held in a vertical fashion by the suction cup against a vertical surface.

U.S. Pat. No. 2,144,876, issued to Garnett is directed to a fishing pole carrier, and is designed to hold poles by means of a suction cup wherein the poles are held in planes parallel to the surface to which the suction cup is attached.

U.S. Pat. No. 7,503,540, issued to Hood is directed to a detachable suction-based holder. The device includes a receptacle portion of the holder with a receiving channel that would hold a pole or conduit-like object. Provision is also made for a suction-actuating lever to assist in attaching the suction cup portion to a smooth surface.

U.S. Pat. No. 6,869,053, issued to Adams, I V is directed to a suction holder for a razor. The plane which includes a ring with an open area is perpendicular to the surface to which the suction cup is attached. Thus, the pole-like device which would be held by the ring would be in a plane that is parallel to the plane of the surface to which the cup is attached.

It is an objective of the present invention to provide a means for making efficient use of available display space in a produce department environment. It is a further objective to provide a system that allows positioning of bag dispenser at different heights. It is a still further objective of the invention to provide a bag dispenser mounting system that is easily adjustable and quickly removable. It is yet a further objective to provide a dispenser mounting system that does not require a permanent mounting or result in damage to mounting surfaces. Finally, it is an objective of the present invention to provide a dispenser mounting system that is durable, inexpensive and easy to clean.

While some of the objectives of the present invention are disclosed in the prior art, none of the inventions found include all of the requirements identified.

### SUMMARY OF THE INVENTION

The present invention addresses all of the deficiencies of prior art pole positioning inventions and satisfies all of the objectives described above.

(1) A suction cup for holding poles providing all of the desired features can be constructed from the following components. A suction cup portion is provided. The suction cup portion is formed of resilient material and has a concave surface and an opposite convex surface. A pole holding assembly is provided. The pole holding assembly is formed of resilient material, has at least one planar surface and is attached to the convex surface such that the planar surface is perpendicular to a plane formed by a perimeter of the concave surface. The assembly has at least one through hole. The through hole is at right angles to the planar surface and is sized and shaped to grip a pole. When the suction cup portion is pressed onto a smooth surface and a pole is positioned within a through hole, the pole will be maintained in a position parallel to the smooth surface.

(2) In a variant of the invention, the suction cup portion further includes a central mounting area. The central mounting area is located at a center of the suction cup portion and has a first thickness greater than a second thickness of the suction cup portion adjacent the perimeter. The pole holding assembly is attached to the central mounting area.

(3) In another variant, the suction cup portion, the central mounting area and the pole holding assembly are formed as one piece.

(4) In still another variant, the pole holding assembly includes three through holes. Each of the through holes is sized and shaped to fit frictionally about a pole.

(5) In yet another variant, each of the through holes is surrounded by resilient material of a first predetermined thickness.

(6) In a further variant, the three through holes are parallel to each other and parallel to the plane formed by the perimeter of the concave surface.

(7) In still a further variant, each of the through holes includes at least one interior ridge. The interior ridge provides additional friction for mounting the pole.

(8) In yet a further variant, a release arm is provided. The release arm has a proximal end and a distal end and is attached at the proximal end adjacent an outer edge of the convex surface. When pressure is applied to the distal end of the release arm, a portion of the perimeter of the concave surface will be separated from the smooth surface and the suction cup will be released from attachment to the smooth surface.

(9) In another variant of the invention, the release arm is curved inwardly toward the central mounting area.

(10) In still another variant, the suction cup for holding poles is fabricated from material selected from the group consisting of plastic, natural rubber, synthetic rubber, unsaturated rubber cured by sulfur vulcanization, unsaturated rubber cured by non-sulfur vulcanization, saturated rubber, and non-rubber elastomers.

(11) In yet another variant, the suction cup for holding poles is combined with at least one pole. The pole is sized and shaped to have a frictional fit in one of the through holes.

(12) In a final variant, the suction cup for holding poles is combined with at least one pole and at least one bag dispenser attached to one of the poles.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention as used to support a pole with attached bag dispenser fastened to a flat surface;

FIG. 2 is an enlarged perspective view of the preferred embodiment; and

FIG. 3 is a cross-sectional view of the FIG. 1 embodiment taken along the line 3-3.

### DETAILED DESCRIPTION OF THE PREFERRED EMBODIMENT

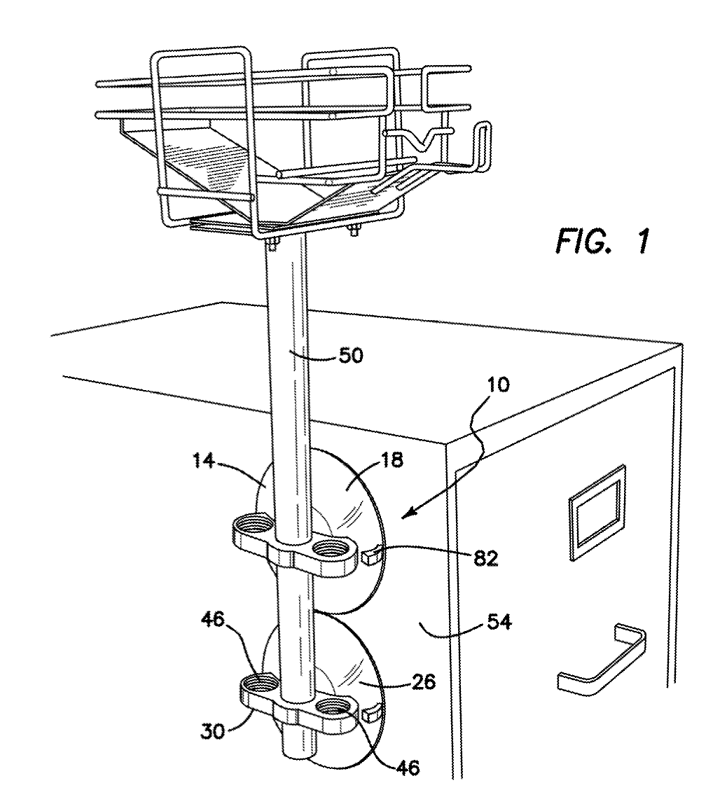

(1) FIGS. 1-3 illustrate a suction cup for holding poles 10 providing all of the desired features that can be constructed from the following components. A suction cup portion 14 is provided. The suction cup portion 14 is formed of resilient material 18 and has a concave surface 22 and an opposite convex surface 26. A pole holding assembly 30 is provided. The pole holding assembly 30 is formed of resilient material 18, has at least one planar surface 34 and is attached to the convex surface 26 such that the planar surface 34 is perpendicular to a plane 38 formed by a perimeter 42 of the concave surface 26. The assembly 30 has at least one through hole 46. The through hole 46 is at right angles to the planar surface 34 and is sized and shaped to grip a pole 50. As illustrated in FIG. 3, when the suction cup portion 14 is pressed onto a smooth surface 54 and a pole 50 is positioned within a through hole 46, the pole 50 will be maintained in a position parallel to the smooth surface 54.

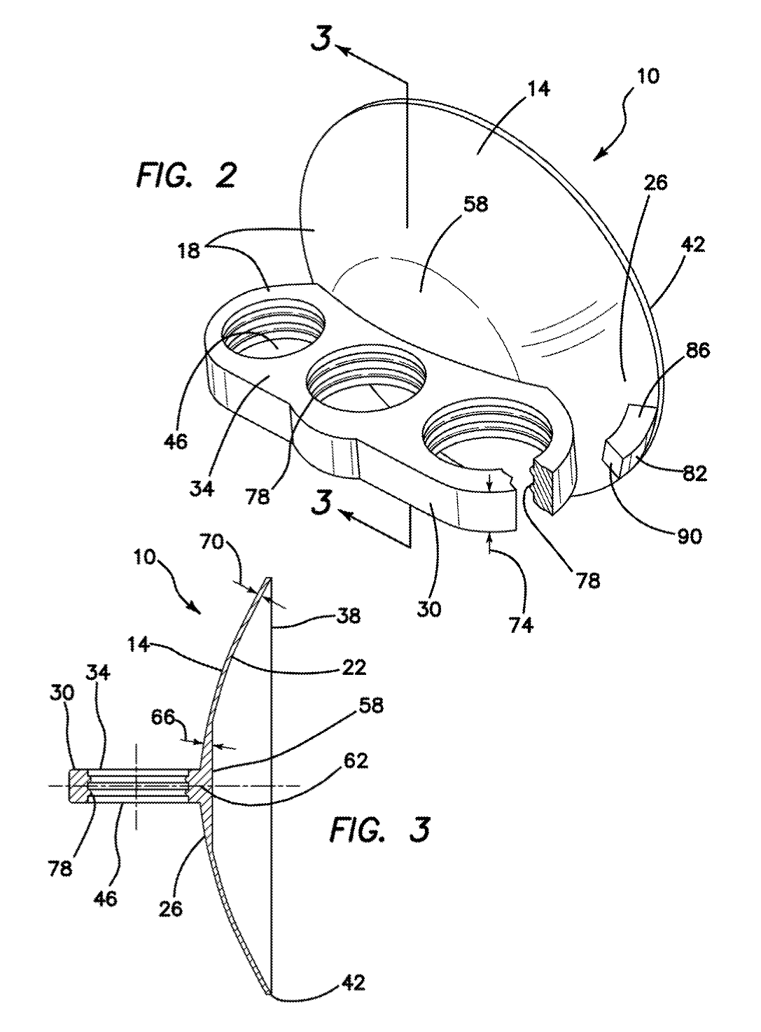

(2) In a variant of the invention, as illustrated in FIGS. 2 and 3, the suction cup portion 14 further includes a central mounting area 58. The central mounting area 58 is located at a center 62 of the suction cup portion 14 and has a first thickness 66 greater than a second thickness 70 of the suction cup portion 14 adjacent the perimeter 42. The pole holding assembly 30 is attached to the central mounting area 58.

(3) In another variant, the suction cup portion 14, the central mounting area 58 and the pole holding assembly 30 are formed as one piece.

(4) In still another variant, the pole holding assembly 30 includes three through holes 46. Each of the through holes 46 is sized and shaped to fit frictionally about a pole 50.

(5) In yet another variant, each of the through holes 46 is surrounded by resilient material 18 of a first predetermined thickness 74.

(6) In a further variant, the three through holes 46 are parallel to each other and parallel to the plane 38 formed by the perimeter 42 of the concave surface 26.

(7) In still a further variant, each of the through holes 46 includes at least one interior ridge 78. The interior ridge 78 provides additional friction for mounting the pole 50.

(8) In yet a further variant, a release arm 82 is provided. The release arm 82 has a proximal end 86 and a distal end 90 and is attached at the proximal end 86 adjacent an outer edge 90 of the convex surface 26. When pressure is applied to the distal end 90 of the release arm 82, a portion of the perimeter 42 of the concave surface 26 will be separated from the smooth surface 54 and the suction cup 10 will be released from attachment to the smooth surface 54.

(9) In another variant of the invention, the release arm 82 is curved inwardly toward the central mounting area 58.

(10) In a still another variant, the suction cup for holding poles 10 is fabricated from material selected from the group consisting of plastic, natural rubber, synthetic rubber, unsaturated rubber cured by sulfur vulcanization, unsaturated rubber cured by non-sulfur vulcanization, saturated rubber, and non-rubber elastomers.

(11) In yet another variant, as illustrated in FIG. 1, the suction cup for holding poles 10 is combined with at least one pole 50. The pole 50 is sized and shaped to have a frictional fit in one of the through holes 46.

(12) In a final variant, the suction cup for holding poles 10 is combined with at least one pole 50 and at least one bag dispenser 94 attached to one of the poles 50.

The suction cup for holding poles 10 has been described with reference to particular embodiments. Other modifications and enhancements can be made without departing from the spirit and scope of the claims that follow.

1. A suction cup for holding poles, comprising:
a suction cup portion, said suction cup portion being formed of resilient material and having a concave surface and an opposite convex surface;
a pole holding assembly, said pole holding assembly being formed of resilient material, having at least one planar surface and being attached to said convex surface such that said planar surface is perpendicular to a plane formed by a perimeter of said concave surface;
said assembly having at least one through hole, said through hole being orthogonal to said planar surface and being sized and shaped to fit frictionally about a pole; and
whereby, when said suction cup portion is pressed onto a smooth surface and a pole is positioned within said at least one through hole, said pole will be maintained in a position parallel to said smooth surface.

2. The suction cup for holding poles as described in claim 1, wherein:
said suction cup portion further comprises a central mounting area, said central mounting area being disposed at a center of said suction cup portion and having a first thickness greater than a second thickness of said suction cup portion adjacent said perimeter; and
said pole holding assembly being attached to said central mounting area.

3. The suction cup for holding poles as described in claim 1, wherein said suction cup portion, said central mounting area and said pole holding assembly are integral.

4. The suction cup for holding poles as described in claim 1, wherein said pole holding assembly comprises three through holes, each of said through holes being sized and shaped to fit frictionally about a pole.

5. The suction cup for holding poles as described in claim 4, wherein each of said through holes is surrounded by resilient material of a first predetermined thickness.

6. The suction cup for holding poles as described in claim 4, wherein said three through holes are parallel to each other and parallel to said plane formed by said perimeter of said concave surface.

7. The suction cup for holding poles as described in claim 1, wherein each of said through holes further comprises at least one interior ridge, said interior ridge providing additional friction for mounting said pole.

8. The suction cup for holding poles as described in claim 1, further comprising:
a release arm, said release arm having a proximal end and a distal end and being attached at said proximal end adjacent an outer edge of said convex surface; and
whereby, when pressure is applied to said distal end of said release arm, a portion of said perimeter of said concave surface will be separated from said smooth surface and said suction cup will be released from attachment to said smooth surface.

9. The suction cup for holding poles as described in claim 8, wherein said release arm is curved inwardly toward said central mounting area.

10. The suction cup for holding poles as described in claim 1 is fabricated from material selected from the group consisting of: plastic, natural rubber, synthetic rubber, unsaturated rubber cured by sulfur vulcanization, unsaturated rubber cured by non-sulfur vulcanization, saturated rubber, and non-rubber elastomers.

11. The suction cup for holding poles as described in claim 1, further comprising at least one pole, said pole being sized and shaped to fit frictionally in one of said through holes.

12. The suction cup for holding poles as described in claim 11, further comprising at least one bag dispenser, said bag dispenser being attached to one of said poles.
